(19) United States
(12) Patent Application Publication
(10) Pub. No.: US 2005/0289207 A1
(43) Pub. Date: Dec. 29, 2005

(54) Fast fourier transform processor, dynamic scaling method and fast Fourier transform with radix-8 algorithm

(76) Inventors: Chen-Yi Lee, Hsinchu City (TW); Yu-Wei Lin, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/052,876

(22) Filed: Feb. 9, 2005

(30) Foreign Application Priority Data
Jun. 24, 2004 (TW) 93118237

(51) Int. Cl. G06F 15/00

(52) U.S. Cl. 708/404

(57) ABSTRACT

The present invention provides a fast Fourier transform processor, dynamic scaling method and fast Fourier transform with radix-8 algorithm. It reduces quantization errors generated from the operation by using a matrix prefetch buffer-based fast Fourier transform processor. Operation sizes of the matrix prefetch buffer as block sizes the invention adjust the signals against overflow by the status of signals in each block. It can shunt time of complex multiplication operation systematically and reduce operation complexity in butterfly units by utilizing algorithms of 3-step radix-8 fast Fourier transform and re-scheduling. Moreover, the present invention provides a fast Fourier transform processor for realizing the methods and algorithms mentioned above.

### BACKGROUND OF THE INVENTION

1. Field of the Invention

The present invention relates to the technique of fast Fourier transform processor (FFT processor), and more particularly to the architecture of fast Fourier transform processor, dynamic scaling method and fast Fourier transform with radix-8 algorithm.

2. Description of the Prior Art

There is a long-size fast Fourier transform processor (FFT processor) in some particular wireless communication systems such as Asymmetrical Digital Subscriber Line (ASDL), Very-High-Speed Digital Subscriber Line VSDL), Digital Audio Broadcasting (DAB), and Digital Video Broadcasting Terrestrial (DVB-T) for increasing the transmission bandwidth and efficiency. An FFT processor can take much area of chip and consumes a lot of power in digital audio/video broadcast systems. SQNR, (Signal to quantization noise ratio) attenuates with the increase of the size of FFT; hence. In order to maintain the same SQNR, the long-size FFT processor needs more wordlength than the short-size FFT processor. Block-floating point is a dynamic scaling mechanism usually used for reducing quantization errors and the length of wordlength in FFT processors.

FIG. 1 is a diagram of conventional block-floating point method. It avoids overflow occurring by checking the signal's maximum value and adjusts the scale factor appropriately after completing every stage operations. The points in the circle mean that overflows occur after completing the operation. Meanwhile, the scale factor has to shift right in order to avoid those overflows. However, currently the design of dynamic scaling approach or block-floating point in existence cannot provide the best mechanism for prefetch buffer-based FFT processors. The radix-8 FFT algorithm with low hardware complexity is mostly used and based on the pipeline architecture. It can only utilize serial complex multiplier operations in a single-port memory-based FFT processor for reducing the hardware complexity. But this approach scarifies the performance of the processor.

In conventional prefetch buffer-based FFT processor the overflow block size is determined by points of FFT and the hardware complexity of high radix FFT processor is determined by number of complex multipliers. Therefore, the hardware complexity of this high radix FFT processor is extremely high.

According to the disadvantages motioned above, the present invention provides a dynamic scaling FFT processor and methods to solve these problems.

### SUMMARY OF THE INVENTION

The present invention provides an FFT processor and dynamic scaling method to realize a dynamic scaling mechanism of high SNQR by using the size of the matrix prefetch buffer to determine the size of overflow blocks.

Additionally, the present invention provides radix-8 FFT algorithm which can be implemented effectively by rescheduling, thereby being able to reduce the chip area and power consumption greatly.

Additionally, the present invention employs radix-8 FFT algorithm to effectively reduce the number of complex multipliers and therefore to achieve the purpose of low hardware complexity.

In order to reach the objects above, the present invention provides a dynamic scaling FFT processor including a matrix prefetch buffer. The dynamic scaling method extracts data, carries out block-floating operations and determines the overflow block size by utilizing the size of the matrix prefetch buffer; after completing the operations in the matrix prefetch buffer, the data corresponding to belonged block without overflow is restored by prescaling the data size dynamically according to the condition of data overflow and block size.

Moreover, the present invention provides radix-8 FFT algorithm. It is used in the Fourier transform with plural stages, wherein the radix-8 FFT algorithm separates a radix-8 butterfly unit into plural steps; then utilizes the re-scheduling method to separate the complex multiplication performed originally in one time in the butterfly unit into plural steps for execution and shifts part of multiplications performed in the first step to the last step of the previous stage for implementation.

The present invention also provides an FFT processor for realizing above methods. It comprises a control unit for controlling and dealing with actions between components. The control unit is coupled to a memory, a matrix prefetch buffer, a butterfly operator and a normalized unit, wherein the memory provides storing data and the prefetch buffer used as a block is in charge to extract data from the memory; next, the butterfly operator extracts data from the matrix prefetch buffer for carrying out butterfly operations and the operated data will be stored back to the matrix prefetch buffer for determining the scale factor of blocks by using the data, which is operated by the matrix prefetch buffer each time; the normalized unit renders the belonged block without overflow by scaling data size according to the determined scale factor before the data stored into the memory.

The objects, features and efficacy of the invention will be apparent from the following more detailed descriptions of concrete implemented examples.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1. A diagram of conventional block-floating point method;

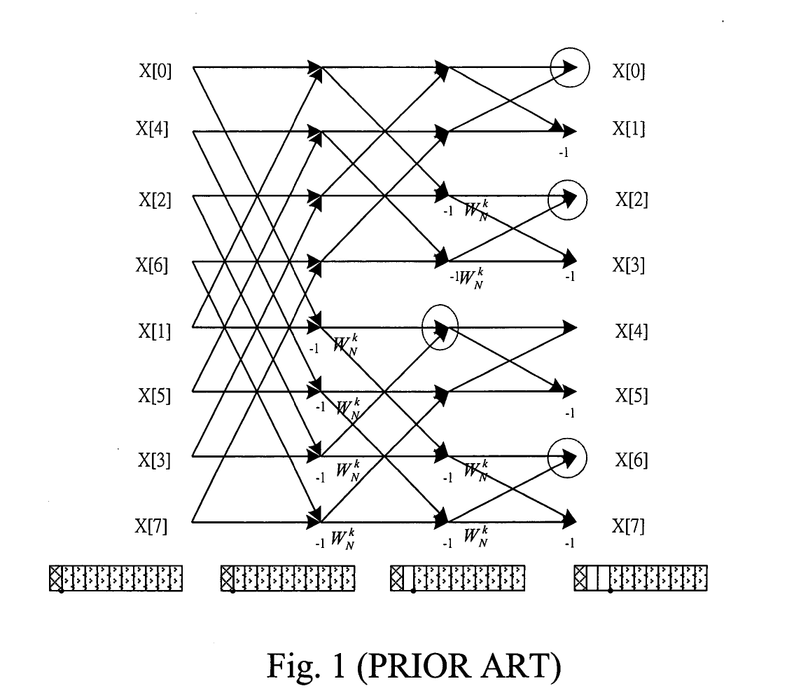

FIG. 2. (a) A diagram of butterflies of radix-8 FFT algorithm. (b) A diagram of butterflies of three-step radix-8 FFT algorithm;

FIG. 3. A time scheduling graph of the complex multiplications: (a) before scheduling, (b) and (c) after scheduling;

FIG. 4. Signal flow chart of the rescheduling algorithm in a 64-point FFT algorithm;

FIG. 5. Operation modes of butterfly units in rescheduling approach;

FIG. 6. A flow chart of rescheduling algorithm;

FIG. 7. Architecture of the hardware suitable for a dynamical scaling approach;

FIG. 8. A block diagram of block-floating point method;

FIG. 9. SQNR for 8 K FFT with the invented, fixed point and block-floating point approaches;

FIG. 10. A block diagram of the invented FFT architecture;

FIG. 11. (a) Operation of the matrix prefetch buffer at the first stage. (b) Operation of the matrix prefetch buffer at the second stage; and

FIG. 12. Scheduling of data of the matrix prefetch buffer operated with butterfly units and exchanged with memory.

### DESCRIPTION OF THE SYMBOLS

10 prefetch buffer
12 memory
14 butterfly unit
20 FFT processor
22 control unit
24 memory
26 matrix prefetch buffer
28 complex multiplier
30 butterfly operator
32 normalized unit
34 buffer
36 common bus
38 record table
40 ROM
42 butterfly unit

### DESCRIPTION OF THE PREFERRED EMBODIMENTS

The present invention provides a long-size FFT processor in which a new dynamical scaling approach and a novel matrix prefetch buffer are exploited. Moreover, a radix-8 FFT algorithm with data rescheduling is used for realizing radix-8 FFF more effectively.

For saving power consumption effectively, it develops a radix-8 FFT which avoids the disadvantage of multiplication complexity of conventional radix-2 algorithm. The operating process of N-point FFT (N=8^{v}) is described as follows.

The N-points Discrete Fourier Transform (DFT) of a sequence x(n) is defined as:

$$X ( k ) = {\sum }_{n = 0}^{N - 1} x ( n ) {W}_{N}^{nk} , k = 0 … N - 1 , \qquad ( 1 )$$

Where x(n) and X(k) are complex number and the twiddle factor is W_{N}^{nk}=e^{-j(2πnk/N)}.

First, let n=n₁+8n₂, k=N/8k₁+k₂, n₁,k₁=0 . . . 7, and n₂,k₂=0 . . . N/8−1. (1) can be rewritten as:

$$\begin{matrix}X ( N / 8 {k}_{1} + {k}_{2} ) = {\sum }_{{n}_{1} = 0}^{7} {\sum }_{{n}_{2} = 0}^{N / 8 - 1} x ( {n}_{1} + 8 {n}_{2} ) {W}_{N}^{( {n}_{1} + 8 {n}_{2} ) ( N / 8 {k}_{1} + {k}_{2} )} = \underbrace{{\sum }_{{n}_{1} = 0}^{7} \{ \underbrace{{\sum }_{{n}_{2} = 0}^{N / 8 - 1} x ( {n}_{1} + 8 {n}_{2} ) {W}_{N / 8}^{{n}_{2} {k}_{2}}}_{N / 8 point DFT} \underbrace{{W}_{N}^{{n}_{1} {k}_{2}}}_{twiddle factor} \} {W}_{8}^{{N}_{1} {k}_{1}}}_{8 point DFT} . & ( 2 ) \\ Where {BU}_{N / 8} ( {n}_{1} , {k}_{2} ) = {\sum }_{{n}_{2} = 0}^{N / 8 - 1} x ( {n}_{1} + 8 {n}_{2} ) {W}_{N / 8}^{{n}_{2} {k}_{2}} . & ( 3 )\end{matrix}$$

Equation (2) can be considered as two-dimensional DFT. By decomposing the N/8-point DFT into an 8-point DFT recursively v−1 times, where v is equal log_{g}^{N}. We can complete the N-point decimation in time (DIT) radix-8 FFT algorithm.

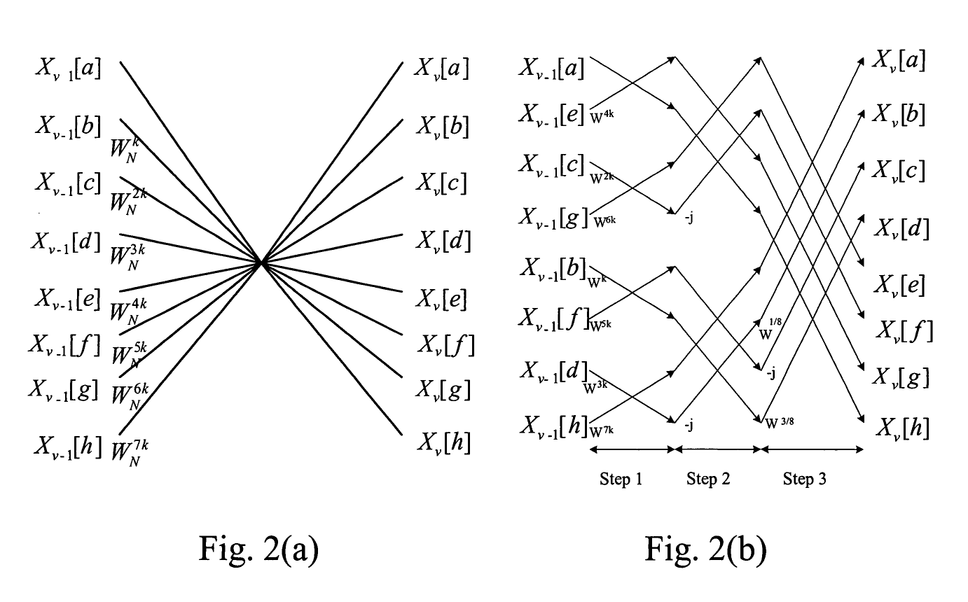

In (2), the 8-point DFT, which is a basic operation unit, is called the butterfly, and is also called butterfly unit (BU) in an FFT processor in hardware implementation, as shown in FIG. 2 (a). It is clearly seen from the figure that 7 complex multipliers, corresponding to 28 real multipliers, is installed in a butterfly unit in the implemented example of the 8-point DFT. In order to implement radix-8 FFT algorithm more efficiently, the present invention further decomposes the butterfly of radix-8 algorithm into three steps and applies the radix-2 index map to the butterfly of radix-8 algorithm. Applying a three-dimensional linear index map, n, and k, can be defined as:
n₁γ₁+2γ₂+4γ₃ γ₁,γ₂,γ₃ε{0,1}
k₁=4ν₁+2ν₂+1ν₃ ν₁,ν₂,ν₃ε{0,1}. (4)
By means of (4), (2) has the following form:

$$\begin{matrix}\begin{matrix}X ( \frac{N}{2} {v}_{1} + \frac{N}{4} {v}_{2} + \frac{N}{8} {v}_{3} + {k}_{2} ) = {\sum }_{{γ}_{3} = 0}^{1} {\sum }_{{γ}_{2} = 0}^{1} {\sum }_{{γ}_{1} = 0}^{1} \{ {BU}_{N / 8} ( {γ}_{1} , {γ}_{2} , {γ}_{3} , {k}_{2} ) {W}_{N}^{( {γ}_{1} , 2 {γ}_{2} + 4 {γ}_{3} ) {k}_{2}} \} {W}_{8}^{4 {γ}_{1} {v}_{1}} {W}_{8}^{2 {γ}_{1} {v}_{2}} {W}_{8}^{4 {γ}_{2} {v}_{2}} {W}_{8}^{( {γ}_{1} + 2 {γ}_{2} ) {v}_{3}} {W}_{8}^{4 {γ}_{3} {v}_{3}} \\ = {\sum }_{{γ}_{1} = 0}^{1} {\sum }_{{γ}_{2} = 0}^{1} {\sum }_{{γ}_{3} = 0}^{1} \underbrace{\{ \underbrace{\{ \underbrace{{TU}_{N / 8} ( {γ}_{1} , {γ}_{2} , {γ}_{3} , {k}_{2} ) {W}_{2}^{{γ}_{1} {v}_{1}}}_{1 st step} {W}_{4}^{{γ}_{1} {v}_{2}} {W}_{2}^{{γ}_{2} {v}_{2}} \}}_{2 nd step} {W}_{8}^{( {γ}_{1} + 2 {γ}_{2} ) {v}_{3}} {W}_{2}^{{γ}_{3} {v}_{3}} \} ,}_{3 th step}\end{matrix} & ( 5 ) \\ Where {TU}_{N / 8} ( {γ}_{1} , {γ}_{2} , {γ}_{3} , {k}_{2} ) = {BU}_{N / 8} ( {γ}_{1} , {γ}_{2} , {γ}_{3} , {k}_{2} ) {W}_{N}^{( {γ}_{1} + 2 {γ}_{2} + 4 {γ}_{3} ) {k}_{2}} . & ( 6 )\end{matrix}$$

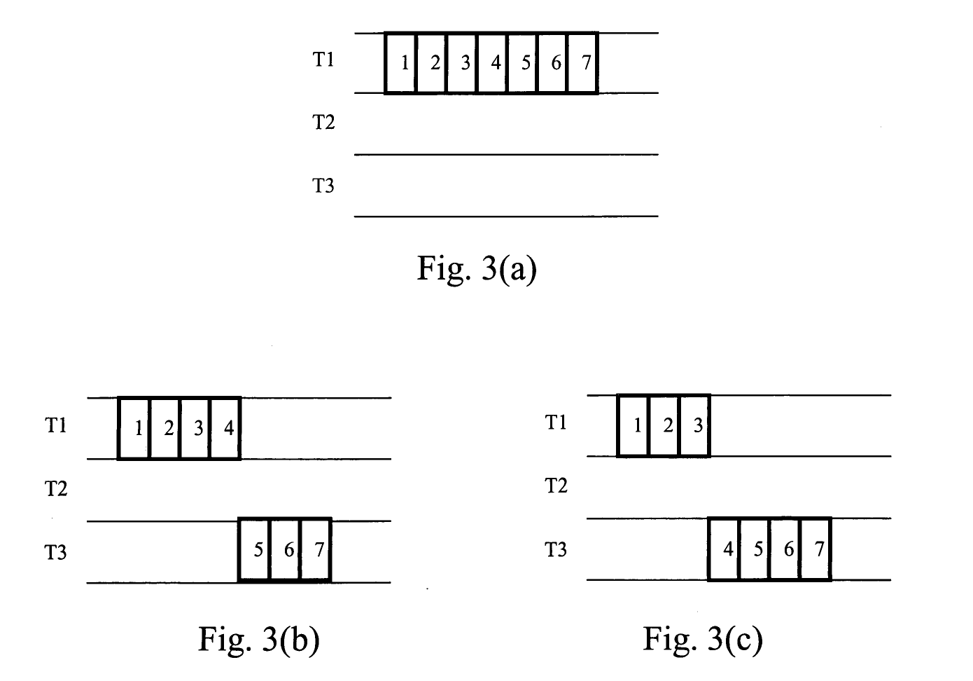

In (5), we use radix-2 index map to divide an 8-point DFT into three steps. FIG. 2(b) shows the butterfly of 3-step radix-8 FFT. Because the trivial multiplication, W₈¹ and W₈³, at the third step can be easily realized by 6 shifters and 4 adders, radix-8 algorithm can reduce lots number of complex multiplications deeply. Please refers to “A new VLSI-oriented FFT algorithm and implementation” (see attachment 1) for knowing how the realization of multipliers can be used with shifters and adders. The original scheduling of complex multiplication in 3-step radix-8 algorithm is shown in FIG. 3(a), where T1, T2, and T3 mean the time slot of each step and the rectangle means complex multiplications in each time slot.

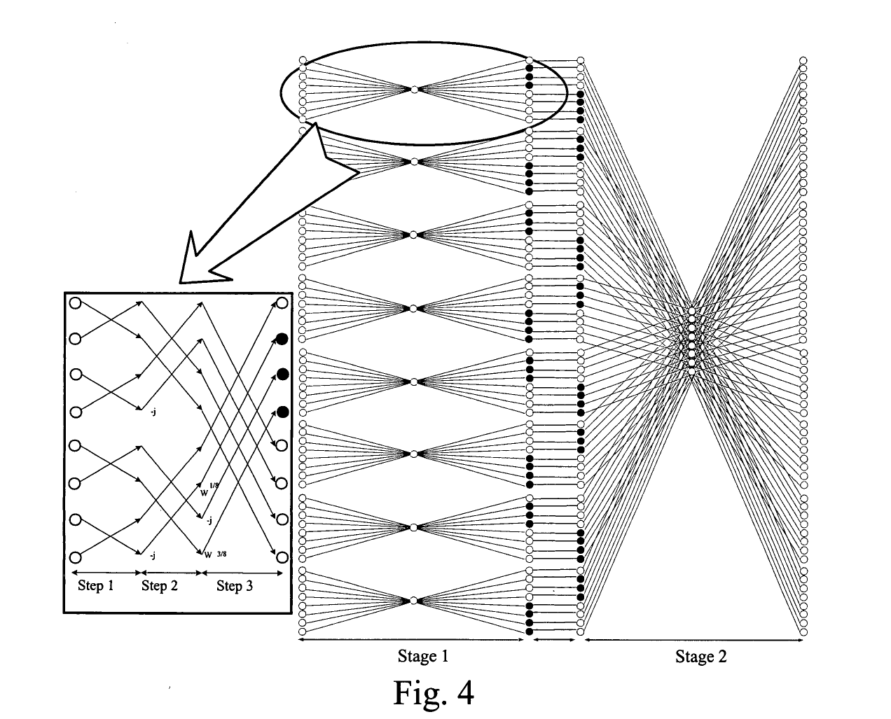

In order to minimize the number of complex multipliers, the present invention proposes a re-scheduling method in 3-step radix-8 FFT algorithm, which is used in 8ⁿ points FFT. The algorithm provides a systematical manner to move some twiddle factors to previous stage and to balance the complex multiplications in three time slots in the butterfly. The black point in FIG. 4 means to multiply the twiddle factor at that point and all the removed twiddle factors are at the third step of the butterfly. Thus, there are at most 4 complex multiplications in each time slot of the butterfly and only 4 complex multipliers are needed in 3-step radix-8 algorithm after re-scheduling. FIG. 3(b) and FIG. 3(c) show the scheduling of the complex multiplication after re-scheduling.

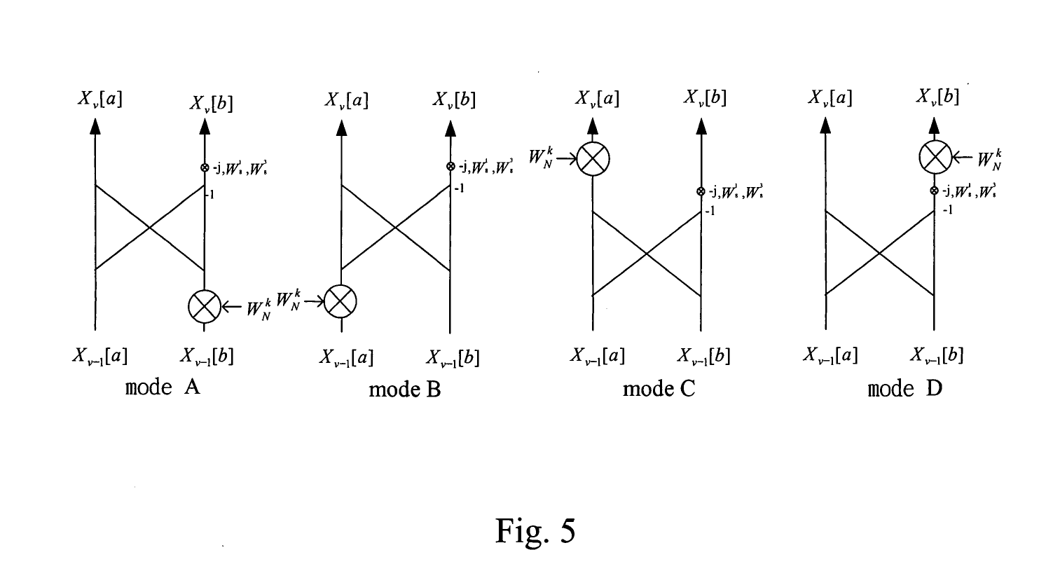

Some operation modes need to be added in FIG. 5 since the twiddle factors are located at both the first and the third steps of the butterfly under the re-scheduling approach as shown in the figure, the operation modes, modes A and B, are operated at the first step of the butterfly; and the other two operation modes, modes C and D, are at the third step of the butterfly.

In order to let 8 data in the processor operate in the same mode at each step of the butterfly to reduce operation complexity, the present invention provides a re-scheduling algorithm for N-points FFT. It determines which groups are moved and the stage to which the groups are moved according to the stages of FFT and number of butterfly groups.

First, we define that:
1. The Stage of N point FFT is from 1 to L (log₈^{N}).
2. The group number in the Lth stage is from 0 to N/8^{L}−1
3. The butterfly number of each group in the Lth stage is from 0 to 8^{(L-1})−1.
4. BU_{—}1 is an operation mode in the first step of butterfly and BU_{—}3 is an operation mode in the third step of butterfly.

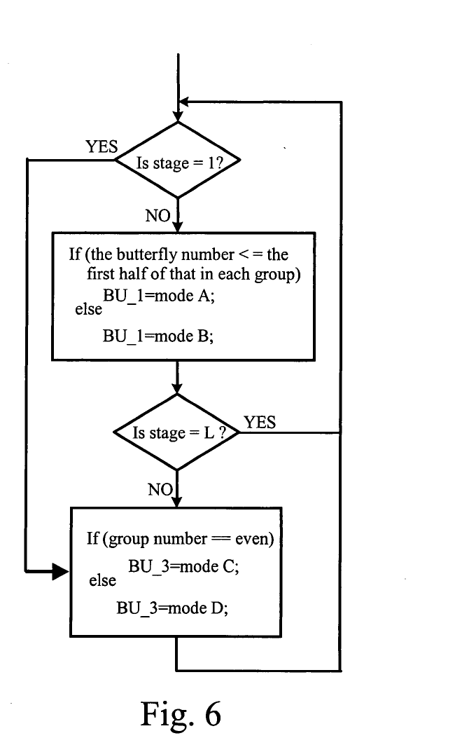

Referring to the flowchart shown in FIG. 6, the re-scheduling algorithm of N-point FFT is as follows:

```
For (stage from 1 to L)
begin
    If (1 ≦ stage ≦ L−1)
    begin
        If (group number is even)
                BU_3=mode C ;
            else
                BU_3=mode D ;
    end
    If (2 ≦ stage ≦ L)
    begin
    If (butterfly number is equal to or less than the first half
        of that in each group)
                  BU_1=mode A ;
              else
                  BU_1=mode B ;
    end
end
```

Dynamic Scaling Method

In order to maintain the data accuracy in fixed-point FFT, the internal wordlength of FFT processor is usually larger than the wordlength of the input data to achieve a higher signal to noise ratio (SNR), especially in a long-size FFT. The block-floating point (BFP), which is one of the dynamic scaling methods, is usually used in FFT processors to minimize the quantization error and the needed wordlenth. In the traditional BFP, the largest value is detected and all computational results are scaled by a scale factor in stage N before starting the calculations of the stage N+1.

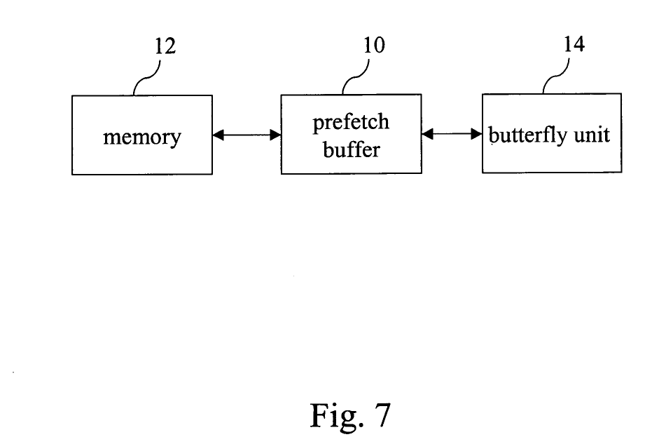

The dynamic scaling method of FFT processors of the present invention is used in prefetch buffers of FFT processors. The hardware architecture to which the dynamic scaling method of the present invention can be applied is shown in FIG. 7. A prefetch buffer 10 is coupled between a memory 12 and a butterfly unit (BU) 14. We will use the architecture mentioned above to assist in describing the dynamic scaling method of the present invention. The method comprises the following steps: First, extracting data in the memory 12 from the prefetch buffer 10, then carrying out the block-floating point operations from the butterfly unit and determining the overflow block sizes according to the size of the prefetch buffer 10 at this time; each time when the data in the blocks are operated completely, based on the data overflow quantity, the scale factors of the blocks will be determined and the size of the data in the blocks scaled so that the data without overflow can be restored to the memory 12. The manner of scaling data size is to shift the position of decimal point therein.

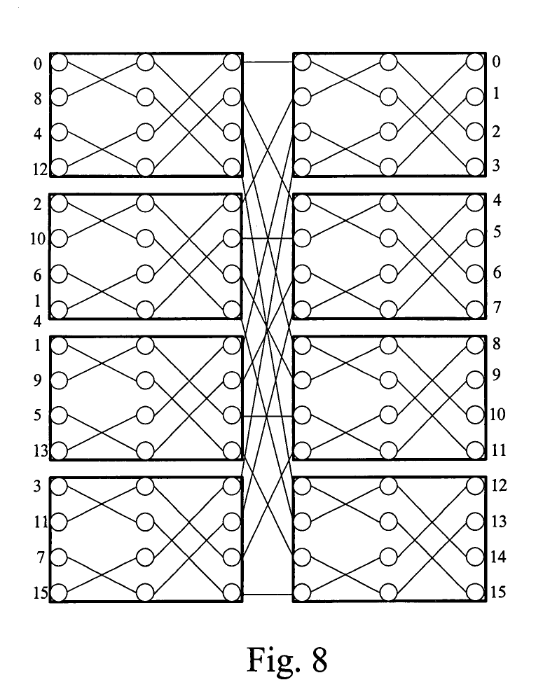

Block-floating point method of the present invention can be executed by prefetch buffer-based FFT processors. It improves the SQNR effectively by enlarging the scale factors and block numbers in the FFT algorithm. FIG. 8 shows an implemented example for 16-point FFT with 4-point block size. It is capable of determining the scale factors of the blocks after the data in the blocks are operated completely each time and scaling the size of the data in the blocks in the previous blocks according to the determined scale factors to avoid the data overflow before starting to operate the next block. All of the scale factors are stored in a table for use in next data operation therein.

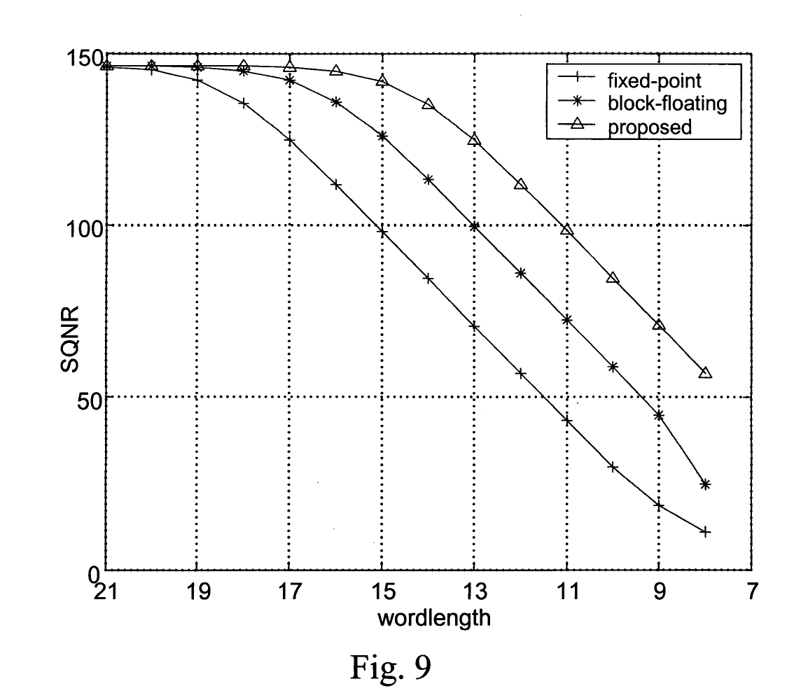

The signal processing quality of three data representations including fixed point, traditional block-floating point, and the proposed approach is simulated. Because the SNR is highly dependent on the input data, we build up a system platform for 8 K mode DVB-T system and all data are generated by this platform. The block size of our approach is 64 points. It is clearly seen that our proposed approach can minimize quantization error efficiently and give much higher SNR than the others at the same wordlength, as shown in FIG. 9.

After understanding the efficacy and dynamic scaling method of FFT processors of the present invention, we will use the architecture of the implemented hardware to describe how to put the method and efficacy into practice.

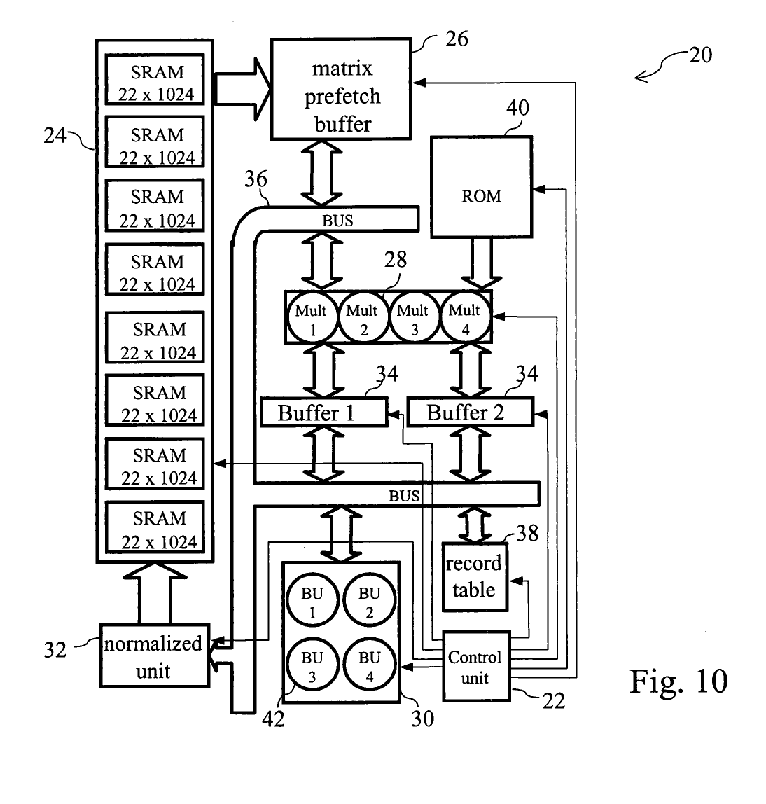

FIG. 10 shows a block diagram of FFT processor of the present invention. An FFT processor 20 comprises a control unit 22. The control unit is coupled to a memory 24, an matrix prefetch buffer 26, four complex multipliers 28, a operator 30 and a normalized unit 32, wherein the control unit controls and deals with actions between components and the memory provides storing data; the matrix prefetch buffer is in charge to extract the data from the memory and its size is used as a block size. Four complex multipliers are coupled between the matrix prefetch buffer and the butterfly operator and also coupled to the ROM 40; they carry out the multiplication operation of the data in the matrix prefetch buffer according the multiplied twiddle factors read out from the normalized unit and then transfers the data to the butterfly operator; the butterfly operator 30 consisting of four butterfly units 42 is used for carrying out butterfly operations of the data operated by multiplication operation and storing the operated data back to the block corresponding to the matrix prefetch buffer and after completing the operations of the data in the matrix prefetch buffer, block scale factors are determined and stored in a record table 38; the normalized unit 32 scales data before the data in each block being operated and stored back into the memory 24. That is, in order to avoid the data overflow, use the normalized unit 32 to scale the data in the previous block according the determined scale factors before operating the data in the next block. Furthermore there installs two buffers 34 between multipliers 28 and the butterfly operator 30 to register data for reducing the reading times of the matrix prefetch buffer; and there is a common bus 36 coupled with the matrix prefetch buffer, the butterfly operator, and the normalized unit.

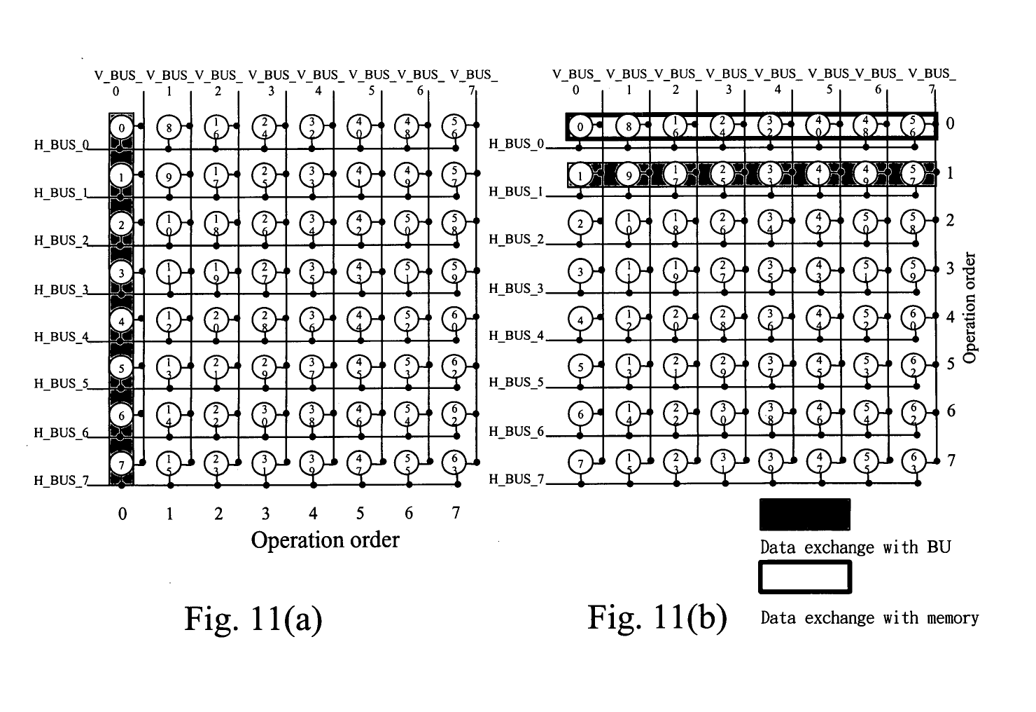

In the present invention, the FFT processor uses three-level memory to improve data processing efficiency. The first level is main memory 24 which is divided into eight data banks to allow concurrent accesses of multiple data and its size is 8K points; the matrix prefetch buffer 26 is the second level which installs 64 points for carrying out the radix-8 operation; the third level is two buffers 34 and each buffer is eight points. Through an appropriate scheduling among three-level memories. Single-port memory can be used in the first and second level without any throughout rate degradation. Therefore, in this design, the wordlength of real number and imaginary number is 11 bits by utilizing dynamic scaling method. The butterfly unit 42 is a core unit of the FFT processor 20; it comprises a trivial multiplier dealing with −j, W₈¹, W₈³ and a complex adder/subtractor; the ROM 40 is a read only memory (ROM) which is used for storing twiddle factors. Only ⅛ period of cosine and sine waveforms can be stored in the ROM and other period waveforms can be reconstructed by these stored values. Data are multiplied by twiddle factors when there are read or written into buffers 34. The data in buffers need three cycles in butterfly units to implement the three-step radix-8 FFT algorithm. Therein, the architecture of the matrix prefetch buffer 26 is shown in FIG. 11 (a) and FIG. 11 (b). Columns 0 to 7 are eight butterflies of the first sage and rows 0 to 7 are eight butterflies of the second stage, as shown in FIG. 4. Eight data in the matrix prefetch buffer 26 are read or written simultaneously in the horizontal or vertical direction each time; the common bus 36 can reduce the wiring complexity of chip manufacture in this architecture.

When data have been completely loaded from the memory 24 in order, The FFT processor 20 starts to implement 64 points FFT with three-step radix-8 algorithm. At the first stage, data are loaded into the matrix prefetch buffer 26 in the column direction in sequence, as shown in FIG. 11 (a). After the operation of multipliers 28, the data are stored in buffers 34 and operated with the butterfly operator 30. All computed data are restored to the same addresses in the matrix prefetch buffer. At the second stage, data are loaded in the matrix prefetch buffer in the row direction in order and the data operation flow is same as that at stage 1; only the operated data are transmitted to the normalized unit 32 for waiting for scaling When the data of row 0 have been loaded into the normalized unit, new data will be loaded into row 0 from the memory, as shown in FIG. 11(b). In next 64 points, the direction of stage 1 will change to row direction because the new data is in row direction.

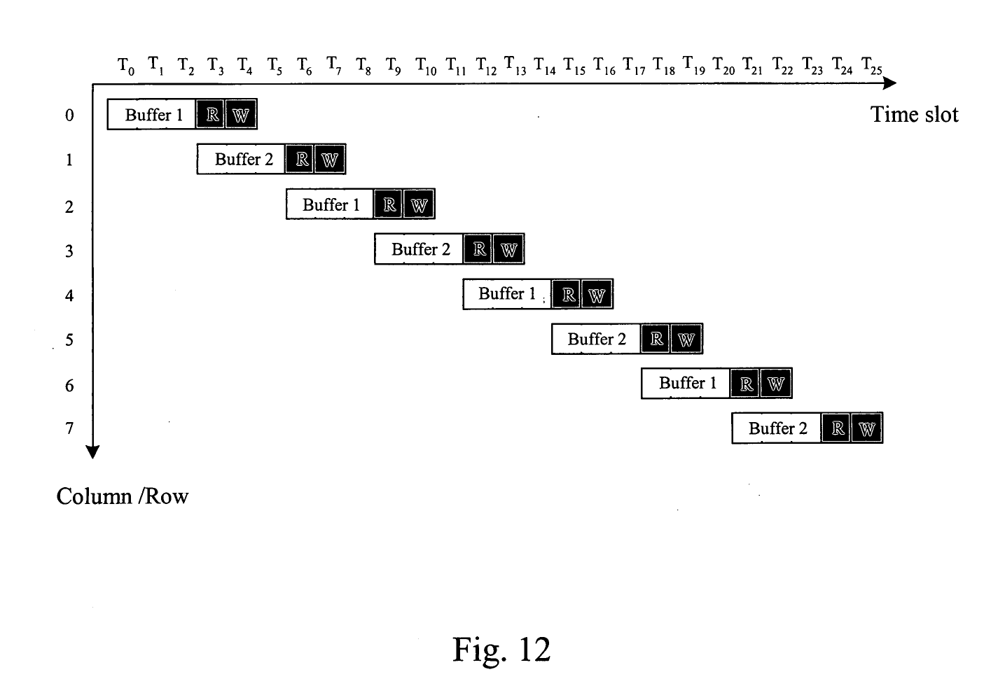

FIG. 12 shows the scheduling of the data in the buffers operated with butterfly units and exchanged with memory. In this figure, the white rectangular is the operational time of the data in buffers; the gray rectangular is the time spent in exchanging the data in the matrix prefetch buffer or loaded into the normalized unit. It can be clearly seen that there is no stall in this scheduling. Similarly, data are loaded from the first level into the second level at the second stage of 64-point FFT and they are restored to the first level from the normalized unit at the first stage of 64-point FFT. Therefore, single-port memory can be used without degrading throughout rate. With the 8 K mode DVB-T system simulation, the wordlength of the real and imaginary parts has about 4 bits less than that of the fixed point when bit error rate (BER) meets the 8 K mode DVB-T standard. So about 64 K bits of memory capacity can be saved by dynamical scaling method.

The present invention uses a matrix prefetch buffer-based FFT processor as a basis and carries out dynamic scaling according to signals overflow condition in each block. It uses the size of the matrix prefetch buffer as a block size to determine if the value in the block needs overflow. It can improve SNQR and reduce quantization errors generated from the operation because the determined overflow block size is smaller than traditional one. Furthermore, using three-step Radix-8 FFT and re-scheduling algorithm to re-schedule the needed operation of the complex multiplication in butterfly units avoids all the operation of complex multiplications at the same time and therefore reduces the number of complex multipliers. This not only has the advantage of low hardware complexity but also reduces the chip area and power consumption.

In the above descriptions, we have made use of the specific implemented examples to explain the features of the present invention. The main aim is to familiarize those people with this technology to understand the content of the invention and to put it into practice. It is evident that various modifications and changes made in these examples without departing the spirit and scope of the invention still have to be included in the scope of the following claims.

1. A dynamic scaling method of fast Fourier transform processor is applied in a fast Fourier transform processor with a matrix prefetch buffer; the dynamic scaling method comprises following steps:
(1) to extract data and compute block-floating;
(2) to determine the overflow block size by utilizing the size of the matrix prefetch buffer; and
(3) after completing the operations in the matrix prefetch buffer, to prescale dynamically the data size according the overflow condition and the block size to make the data to the corresponding block without overflow, then store the data to the memory.

2. The dynamic scaling method of fast Fourier transform processor according to claim 1, wherein the step of dynamic scaling data size is: when the operations of the data in the block is completed, the scale factor of the blocks is determined by the overflow quantity of the data, then using the scale factor to scale the size of the data in the block to avoid the data overflow.

3. The dynamic scaling method of fast Fourier transform processor according to claim 2, wherein the data size is scaled in the previous block before starting the computation of the data in the next block.

4. The dynamic scaling method of fast Fourier transform processor according to claim 1, wherein the method of scaling data size is to shift the position of decimal point

5. A fast Fourier transform with radix-8 algorithm applied in plural-stage Fourier transform, comprising the following steps:
(1) to decompose each stage in a radix-8 butterfly operator into plural steps; and
(2) to utilize rescheduling to separate the complex multiplications executed originally in one time in the butterfly operator at the same stage into plural steps for executing and, shifting part of multiplications from the first step of the stage to the last step of the previous stage for executing simultaneously.

6. The fast Fourier transform with radix-8 algorithm according to claim 5, wherein radix-2 algorithm is applied to radix-8 algorithm in butterfly operations.

7. The fast Fourier transform with radix-8 algorithm according to claim 5, wherein to carry out rescheduling steps, the twiddle factor of the first step of the next stage is moved and rendered to coexist in the last step of the previous stage.

8. The fast Fourier transform with radix-8 algorithm according to claim 5, wherein after rescheduling step, the step of two balance operation modes is included in butterfly operation. That is, the first balance operation mode multiplies the twiddle factor of the first step in the next stage and the second balance operation mode multiplies the twiddle factor of the last step in the previous stage.

9. The fast Fourier transform with radix-8 algorithm according to claim 8, wherein the first and second operation mode comprise plural modes, respectively.

10. The fast Fourier transform with radix-8 algorithm according to claim 5, wherein re-scheduling determines which groups are moved and the stage to which the groups are moved according to the level of stages and number of butterfly groups.

11. A fast Fourier transform processor comprises:
a control unit for controlling and dealing with operation between components;
a memory coupled with a control unit for storing data;
a matrix prefetch buffer as a block size and in charge to extract data from the memory;
plural multipliers coupled with the matrix prefetch buffer for carrying out multiplication of data;
a butterfly operator coupled with multipliers for carrying out butterfly operations of the data in the blocks and storing the operated data back to belonged block, thereby the matrix prefetch buffer being able to determine the scale factor of each block by the operated data; and
a normalized unit, which scale the data size to the belonged block without overflow in according to the determined scale factor before the data stored into memory.

12. The fast Fourier transform processor according to claim 11, capable of determining the scale factor of the belonged block after completing the data operation in the matrix prefetch buffer and before starting to operate the data in next block, of scaling the data by utilizing the determined scale factor in previous block and the normalized unit to avoid the data overflow.

13. The fast Fourier transform processor according to claim 11, wherein the butterfly operator consists of plural butterfly units.

14. The fast Fourier transform processor according to claim 11, wherein the multipliers are complex multipliers.

15. The fast Fourier transform processor according to claim 11, wherein the scale factor of each block is stored in a record table.

16. The fast Fourier transform processor according to claim 11, installing at least one buffer between multipliers and butterfly operator.

17. The fast Fourier transform processor according to claim 11, further comprising a common bus for coupling with the matrix prefetch buffer, the butterfly operator and the normalized unit.

18. The fast Fourier transform processor according to claim 11, further comprising a ROM.
